(19) United States
(12) Patent Application Publication
(10) Pub. No.: US 2023/0409875 A1
(43) Pub. Date: Dec. 21, 2023

(54) Predicting Forecasting Uncertainty

(71) Applicant: Ciena Corporation, Hanover, MD (US)

(72) Inventors: Petar Djukic, Ottawa (CA); Ivan Radovic, Ottawa (CA)

(21) Appl. No.: 17/845,414

(22) Filed: Jun. 21, 2022

(51) Int. Cl. G06N 3/04

(52) U.S. Cl. CPC G06N 3/0454

(57) ABSTRACT

Systems and methods for receiving a time-series that includes a historical or current observation and determining future points of the time-series utilizing a forecasting deep neural network (DNN) to analyze the time-series and determining an uncertainty of the future points utilizing an uncertainty DNN to analyze the time-series and future points. The output would include providing the future points of the time-series and the uncertainty data. The steps further include training the forecasting DNN with historical data and training the uncertainty DNN with the trained forecasting DNN utilizing a residual of an estimate from the forecasting DNN and actual data.

### FIELD OF THE DISCLOSURE

The present disclosure generally relates to forecasting. More particularly, the present disclosure relates to systems and methods for estimating and predicting forecasting aleatoric uncertainty, or the uncertainty due to the randomness in the underlying data.

### BACKGROUND OF THE DISCLOSURE

Time-series forecasting is an important technology with applications in networks, supply chains, healthcare, economics, and others. Time-series pertains to a certain sequence of observations collected in constant time intervals; time-series analysis involves developing models that are used to describe the observed time-series. Time-series forecasting occurs when you make scientific predictions based on historical time stamped data and drive future decisions. Getting good forecasts can improve network efficiency by predicting traffic flows and allowing for better allocation of network resources. Forecasting can also improve business efficiency in terms of buying fewer goods or improving lead times. In terms of network supply chains, forecasting is an essential part in planning processes and influences where traffic should be routed for higher equipment efficiency. Forecasting can also predict where equipment should be added into the network, which equipment should be procured, and when it should be procured. In the environment of a communication network, as another example, network administrators may utilize forecasting models to predict future conditions of the communication network in an attempt to optimize the network, such as by deploying extra equipment where needed, planning routing paths for data packets, etc.

Time-series forecasting typically produces point estimates of some future value, however, the quality of the forecast is important. The quality of the forecast can be evaluated by how much uncertainty there is in the point estimate. There are two types of uncertainty: aleatoric and epistemic uncertainty. Aleatoric (statistical) uncertainty refers to the uncertainty in the forecast due to underlying random effects in the data (otherwise referred to as noisy data). Epistemic (systemic) uncertainty refers to lack of knowledge or the proper fit of the model to the data. From the machine learning perspective aleatoric uncertainty can be thought of as the lack of confidence we have in predictions due to the randomness in the data, while the epistemic uncertainty refers to our confidence that the model is well-fit to the data.

Machine learning is the scientific study of computer algorithms that can improve without using explicit instructions, through experience and by the use of data. Machine learning is a sub-set of artificial intelligence (AI). Machine learning creates and uses models based on sample data, otherwise called training data, in order to make predictions and decisions automatically. Deep learning describes methods of machine learning based on artificial neural networks with representation learning, this method learns and improves on its own by examining computer algorithms. Deep learning architectures such as Deep Neural Networks (DNNs) can model complex non-linear relationships and can generate compositional models where the object is expressed as a layered composition of primitive data types. Neural networks such as DNN comprise of layers of nodes, much like the human brain is made up of neurons, these nodes within individual layers are connected to adjacent layers, and the term “deep” refers to the number of layers through which the data is transformed.

Machine learning based on DNNs can be used to predict how a time-series will behave in the future by using a DNN forecaster architecture. There exists well known conventional methods of estimating epistemic uncertainty, such as the Bayesian drop-out method, which determines if a model is a good fit to the data. However, machine learning methods of estimating aleatoric uncertainty or the uncertainty due to the randomness in the underlying data is extremely difficult especially as the size and complexity of the data and models increase.

### BRIEF SUMMARY OF THE DISCLOSURE

The present disclosure relates to systems and methods for determining uncertainty in a time-series forecast. Specifically, the system and method presented uses future points of a time-series from historical observation of the time-series using a first DNN and uses the historical time-series points and the forecasted time-series points as an input to a second DNN. The second DNN is used to determine the uncertainty of the forecast (uncertainty DNN). The current conventional machine learning methods of determining uncertainty do not determine aleatoric uncertainty, as the uncertainty is random and therefore difficult to model. Without knowing aleatoric uncertainty it is hard to judge if the predictions given in forecasting can be relied upon.

In various embodiments, the present disclosure includes a method with steps, a processing system configured to implement the steps, and a non-transitory computer-readable medium having instructions stored thereon for causing a processing device to implement the steps. The steps include receiving a time-series that includes a historical or current observation; determining future points of the time-series utilizing a forecasting deep neural network (DNN) to analyze the time-series; determining an uncertainty of the future points utilizing an uncertainty DNN to analyze the time-series; and providing the future points of the time-series and the uncertainty.

The steps can include utilizing the uncertainty DNN to analyze the time-series and the future points. The steps can include performing the determining steps concurrently. The forecasting DNN and the uncertainty DNN can include various components including any of dense layers, long short-term memory (LSTM) layers, pooling layers, and convolutional layers. The forecasting DNN and the uncertainty DNN can include different components. The uncertainty can include a range over time. The steps can include training the forecasting DNN with historical data; and training the uncertainty DNN with the trained forecasting DNN utilizing a residual of an estimate from the forecasting DNN and actual data in the historical data. The uncertainty can be any of a variance of noise, a probability the noise is higher than a threshold, and a sign of the noise. The time-series can include performance monitoring (PM) data from a network.

### BRIEF DESCRIPTION OF THE DRAWINGS

The present disclosure is illustrated and described herein with reference to the various drawings, in which like reference numbers are used to denote like system components/process steps, as appropriate, and in which:

FIG. 1 is an example of time-series data illustrating aleatoric uncertainty on the data.

FIG. 2 is a functional block diagram depicting training and inference models of a DNN architecture for predicting time-series future and aleatoric uncertainty.

FIG. 3 is a flow diagram showing an embodiment of a method for predicting forecasting uncertainty, according to various embodiments.

FIG. 4 is a block diagram of a computing system configured to obtain a time-series.

FIG. 5 illustrates the implementation of the predicting architecture of FIG. 2 as described in the disclosure using the time-series data shown in FIG. 1

### DETAILED DESCRIPTION OF THE DISCLOSURE

In various embodiments, the present disclosure relates to systems and methods for estimating and predicting forecasting aleatoric uncertainty.

Example of Data with Aleatoric Uncertainty

By way of example, an application where it is assumed that the network data is the sum of a signal with a recognizable pattern with some additive noise:

xₜ=sₜ+nₜ [Equation 1]

where sₜ is the interesting part of the observations (signal) and nₜ is unknown noise. Signal sₜ is estimated from observations of xₜ as ŝₜ which represents predicted values. The success of the estimation is measured with the residual error of the estimate:

eₜ=|sₜ−ŝₜ| [Equation 2]

Ideally, the error (eₜ) would be as close to 0 as possible.

When estimating sₜ with ŝₜ, the aleatoric uncertainty would come from our lack of knowledge of the noise, therefore the noise prevents an exact estimate. As we are not able to estimate the noise nₜ with \hat{n}ₜ directly as the noise is random, we would like to estimate a statistical property of the noise as it would give us an idea of how close our estimate ŝₜ is to true sₜ in a statistical sense. Noise estimation typically proceeds on by assuming the following: nₜ are 0-mean independent and identically distributed Gaussian random variables [ [symbol] (0, σ)] and then an estimate of the variance σ of nₜ is used to estimate the aleatoric uncertainty of ŝₜ. It should be noted that a Gaussian random process is a stochastic process, or a collection of random variables indexed by time or space, such that every finite collection of the random variables has a multivariate normal distribution. With estimated variance \hat{σ}, [symbol] (0, \hat{σ}) becomes an estimate of the aleatoric uncertainty in \hat{x}ₜ. There are multiple ways of estimating the noise \hat{σ}. For example, using auto-regressive models (AR), one could estimate the running mean \hat{μ}ₜ (with AR modeling this is also ŝₜ), subtract it from xₜ and then estimate the running variance of the residual. With the known variance and the Gaussian assumption one can put probabilistic bounds on the noise around the signal.

The AR model uses observations from previous time steps as input to a regression equation to predict the value at the next time step. The AR model specifies that the output variable depends linearly on its own previous values and on a stochastic term. While the AR model is very nicely packaged and with many mathematical derivations analyzing it, it makes several assumptions on the statistical properties of sₜ and nₜ, which may not be true at all. Most noise is not independent and identically distributed or Gaussian in nature. Being able to estimate sₜ well, we can get an estimate of the noise which is what the AR method is trying to achieve:

\hat{n}ₜ=xₜ−ŝₜ [Equation 3]

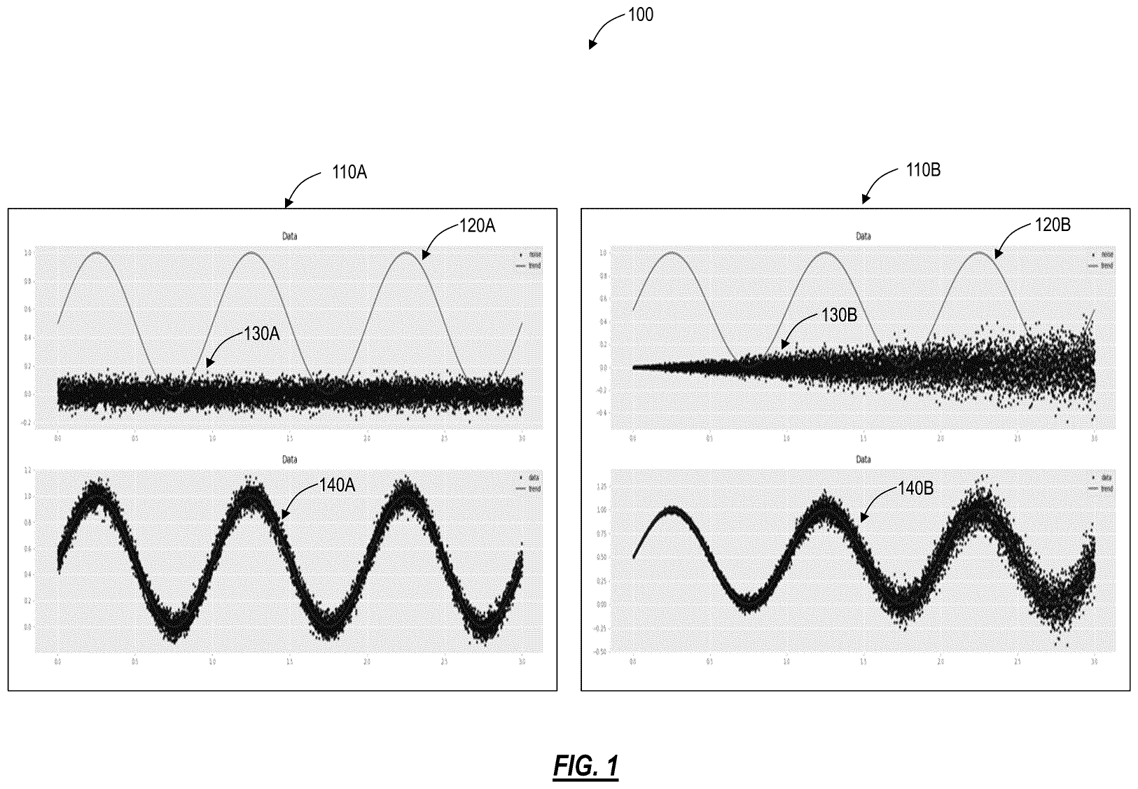

The success of this noise estimate is highly dependent on our ability to make eₜ in Equation 2 very small. FIG. 1 illustrates an example of time series data, noise, and data trend of two time-series plots 110A, 110B. In many cases, a time-series may be plotted in a graph with time referenced on the x-axis and some metric, characteristic, or parameters referenced on the y-axis. The time-series may be a sequence of measurements taken at equally-spaced points in time. The two time-series plots 100 show the same data trend 120A, 120B but two separate types of noise, constant intensity noise (130A) which remains constant irrespective of time, and time varying noise (130B) which increases with time. The data 140A and 140B refers to xₜ, trend (120A,120B) refers to sₜ, and noise (130A,130B) refers to nₜ. It should be observed that the independent and identically distributed approach may work for the constant intensity noise 130A (depending on how well the model of the noise is matched with AR), while it will have a very challenging time estimating the time-varying variance in 130B. What is required to estimate the aleatoric uncertainty for either dataset in FIG. 1 is an adaptive approach that learns how to estimate the noise level from its knowledge of the specific data.

### Time-Series Data Forecasting

A network time-series is a sequence of measurements xₜ, xₜ₊₁, . . . , xₜ₊ₖ, xₜ₊ₖ₊₁ . . . , x_{t+k+w} and forecasting is the process of using historical points xₜ, xₜ₊₁, . . . , xₜ₊ₖ to predict future points xₜ₊ₖ₊₁ . . . , x_{t+k+w}. The prediction is denoted by \hat{x}ₜ₊ₖ₊₁ . . . , \hat{x}_{t+k+w} and the error in the prediction can be found with:

(eₜ₊ₖ₊₁, . . . ,e_{t+k+w})=(xₜ₊ₖ₊₁ . . . ,x_{t+k+w})−(\hat{x}ₜ₊ₖ₊₁ . . . ,\hat{x}_{t+k+w}) [Equation 4]

The total magnitude of the error can also be evaluated by measuring the distance between the predicted time-series and the actual points which are observed sometime after the prediction:

ε(k+1,k+w)=∥(xₜ₊ₖ₊₁ . . . ,x_{t+k+w})−(\hat{x}ₜ₊ₖ₊₁ . . . ,\hat{x}_{t+k+w})∥ [Equation 5]

A time-series can be modeled as an unknown signal in unknown noise as shown in Equation 1 above, therefore the forecasting problem can be also thought of as estimating the unknown signal, characterized as a function of time. Forecasting works by using past points to estimate the function and then projecting the future points from the estimated function. It has been shown in previous art that it is possible to train a deep neural network (DNN):

f(xₜ,xₜ₊₁, . . . ,xₜ₊ₖ,θ): [symbol] → [symbol] [Equation 6]

With parameters θ, which takes k timepoints xₜ, xₜ₊₁ . . . , xₜ₊ₖ and maps them onto w predicted timepoints \hat{x}ₜ₊ₖ₊₁ . . . , \hat{x}_{t+k+w} so that the error E is very, very small. Small error is achieved because the DNN stochastic (randomly determined) optimization aims to estimate the mean of xₜ as the maximum likely estimate of the unknown signal sₜ. The small error means that on a historical dataset, the predictions accurately predict how time-series will behave in the future, considering that noise must have a zero mean.

### Machine Learning Forecasters

Machine learning works in two main phases, training and inference, where models can be created for both phases. The training model uses a curated data-set so that it can learn from the type of data it will analyze. The inference model makes predictions based on the data-set to produce the desired result. Using machine learning and in particular DNN architecture for forecasting a time-series is a well-defined method that can be used for univariate (single time-dependent variable) as well as multivariate (more than one time-dependent variable) time-series. The DNN Forecaster may be configured as but not limited to ResNet forecasters (e.g., the ResNet forecaster used in application Ser. No. 16/687,902), which may be single variate forecasters. In another example, the DNN forecasters may be configured as Long Short-Term Memory (LSTM) forecasters based on LSTM techniques.

Multi-variate forecasters can include mixer architecture for mixing multi-variate time series inputs obtained from a system (e.g., the DNN mixers used in application Ser. No. 16/833,781). A DNN architecture can be arranged such that the DNN mixer operates at an input of the DNN routine and the DNN architecture can be arranged such that the DNN mixer operates at an output of the DNN routine. A forecaster may include a DNN architecture where a first DNN mixer operates at an input of the routine and a second DNN mixer operates at an output of the routine. In this case, the DNN forecasters may be arranged in between the first and second DNN mixers. The input DNN mixer and the output DNN mixer in this architecture may have the same weights or may have different weights.

Low-capacity forecasters which include stochastic processes can be used to model time-series data, particularly if the training is done through an automatic differentiation procedure. Some examples of low-capacity forecasters include Auto-regressive integrated moving average (ARIMA), Kalman filter, etc. These types of models use past values of the time-series to predict future values and are used where data show regular and predictable patterns, as a one-time shock in the data will affect subsequent values into the future.

### Predicting Time-Series Future and Aleatoric Uncertainty

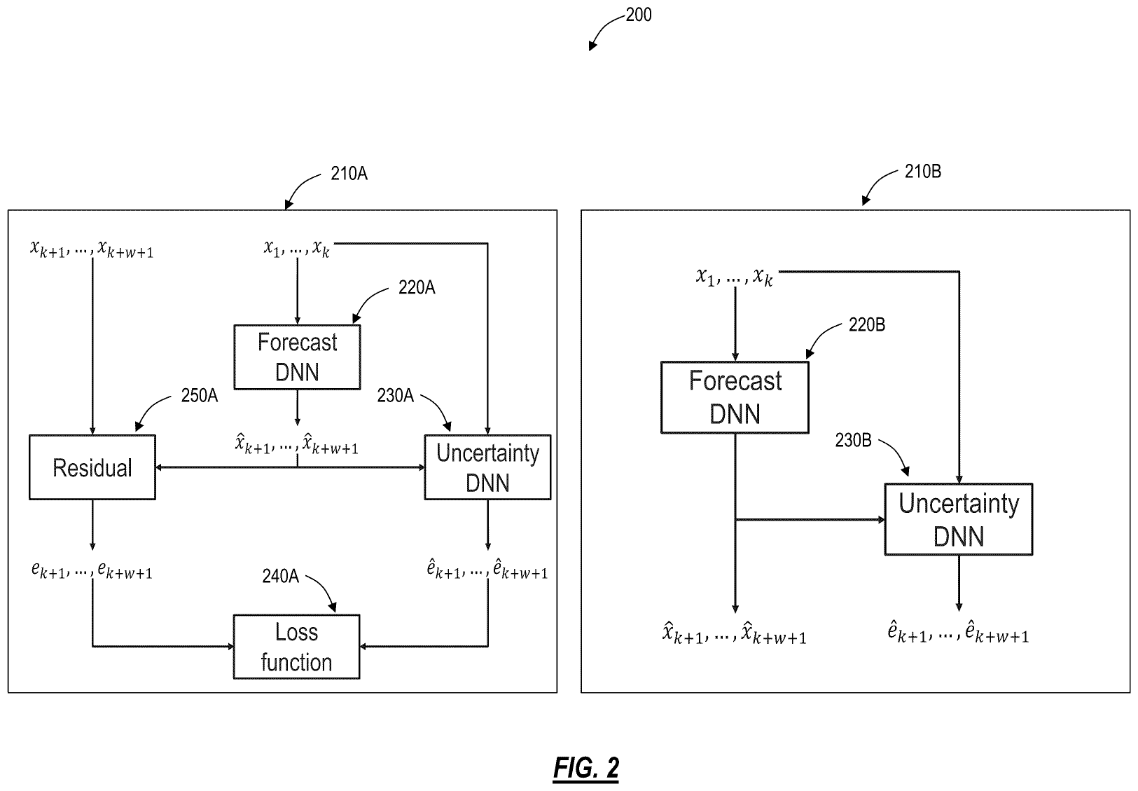

DNN architecture consists of a training phase and an inference phase, as applied to the uncertainty prediction, FIG. 2 shows an embodiment of the architecture, where 210A shows the training architecture and 210B shows the inference architecture. The aleatoric uncertainty can be predicted with a properly trained DNN as shown in 210A. In that architecture a forecast DNN (220A) is a block in a much larger architecture. The forecasting block (220A) could be any one of the forecasting architectures including single-variate ResNet forecasters (e.g. the ResNet forecaster used in application Ser. No. 16/687,902), single-variate LSTM forecasters, multi-variate LSTM forecasters (e.g., the multi-variate forecasters used in application Ser. No. 16/833,781), or any other forecasting DNN. In the training architecture, the forecasting block creates estimates of the future time-points xₜ₊ₖ₊₁ . . . , \hat{x}_{t+k+w}, which is used to calculate the residual of the estimate eₜ₊ₖ₊₁ . . . , e_{t+k+w} using Equation 4. Note that during training, the future values of the time-series are available as they are only future, relative to other points the dataset (which itself consists of historical measurements).

The estimates of future time-points \hat{x}ₜ₊ₖ₊₁ . . . , \hat{x}_{t+k+w} are also used as input to the uncertainty DNN (230A) which estimates the aleatoric uncertainty of the forecasting input xₜ₊ₖ₊₁ . . . , x_{t+k+w}. For illustration, the uncertainty DNN block (230A) produces an estimate of the residual êₜ₊ₖ₊₁ . . . , ê_{t+k+w} as the indication of aleatoric uncertainty.

Other outputs are also possible from the uncertainty DNN block (230A). For example, the uncertainty DNN (230A) could produce the variance of the noise, or a probability that a noise is higher than a given threshold. In the former case, the uncertainty DNN would operate on n-point forecasts where n is the forecasting horizon we are trying to predict. This uncertainty DNN would accept the same inputs and produce an estimate of the mean and variance of the error as its output. This mean and variance estimate could then be used to generate confidence intervals for the forecasts over the given forecast horizon. These confidence intervals could be constructed under the assumption of Gaussian noise, or any other distribution. Similarly, the uncertainty DNN (230A) could be trained to produce estimates of any desired statistics of the noise signal. Thus, this approach does not necessarily need to assume the distribution of the noise. The confidence intervals produced by these estimates would act as an alternative manner of estimating uncertainty in our forecasts.

In another case, a DNN could be used to perform classification on the sign of the noise. It would have the same inputs as the uncertainty DNN but would instead predict a label that corresponds to the sign of the error. For example, a 0 label could correspond to the forecast underestimating the target value and a label of 1 could correspond to the forecast overestimating the target value. This uncertainty DNN could then be trained in addition to the two seen in 210A, so that the user has additional information on the prediction. In this case, the user would also gain insight into what type of error was made on the forecast e.g. over or underestimating the true value. Furthermore, it can be easily combined with any other form of uncertainty estimation if so desired.

The estimates of the residual from the uncertainty DNN (230A) and the true residuals from the residual block (250A) are passed to a loss function (240A), which is used to set the DNN weights in either DNN (forecast or uncertainty). One example of the loss function is:

L=αε(k+1,k+w)+(1−α)E(k+1,k+w) [Equation 7]

Where,

E(k+1,k+w)=∥(eₜ₊ₖ₊₁ . . . ,e_{t+k+w})−(êₜ₊ₖ₊₁ . . . ,ê_{t+k+w})∥ [Equation 8]

It should be clear that the training procedure will simultaneously optimize two DNNs through the process of stochastic optimization. The forecasting DNN is defined by Equation 6 and its optimum weights are found because of the ε(k+1, k+w) term in the loss function (240A). The optimum weights for the uncertainty DNN (230A) are found because of the E(k+1, k+w) term in the loss function. We note that an alternative way to train the two DNNs is to make the optimization sequential, that is train the forecasting DNN (220A) first and then train the uncertainty DNN (230A). However, it is simpler to train both at the same time.

The inference architecture is shown in 210B. Note that only the historical points xₜ₊ₖ₊₁ . . . , x_{t+k+w} are used as an input to the inference DNN. The actual future points were only used during training to create a regression output that the network should produce. The architecture first utilizes the forecasting DNN (220B) to predict the future points of the time-series \hat{x}ₜ₊ₖ₊₁ . . . , \hat{x}_{t+k+w} and it then uses the historical and the predicted future points to estimate the residual of the prediction and the actual prediction êₜ₊ₖ₊₁ . . . , ê_{t+k+w}. Note that if the prediction \hat{x}ₜ₊ₖ₊₁ . . . , \hat{x}_{t+k+w} is perfect, then the prediction êₜ₊ₖ₊₁ . . . , ê_{t+k+w} corresponds to the unpredictable part of the time-series (the noise). It should be clear that the two DNN blocks (220B and 230B) can be implemented in a variety of DNN architectural blocks including but not limited to “dense” layers, Long Short-Term Memory (LSTM) layers or convolutional or pooling layers. It should be noted that this prediction method can be applied to real numbers as well as discrete numbers.

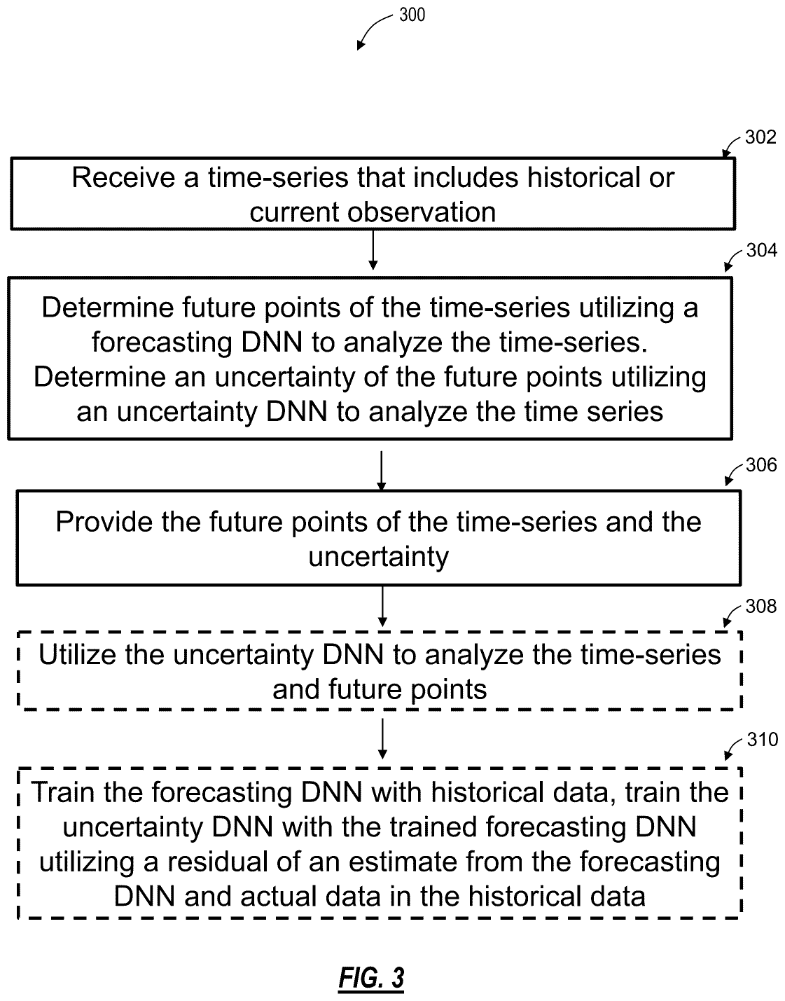

FIG. 3 is a flow diagram showing an embodiment of a method for estimating and predicting forecasting aleatoric uncertainty. The method 300 includes receiving a time-series that includes historical or current observation 302. By using the DNN architecture which includes an uncertainty DNN as shown in 200, determining future points of the time-series utilizing a forecasting DNN to analyze the time-series, and determine the uncertainty of the future points by utilizing the uncertainty DNN (304). The output is the future points of the time-series data and the uncertainty data (306). The uncertainty DNN can be utilized to analyze the time-series and future points 308. The forecasting DNN will be trained with historical data and the uncertainty DNN will be trained with forecasting DNN utilizing a residual of an estimate from the forecasting DNN and actual data in the historical data 310.

### Processing System

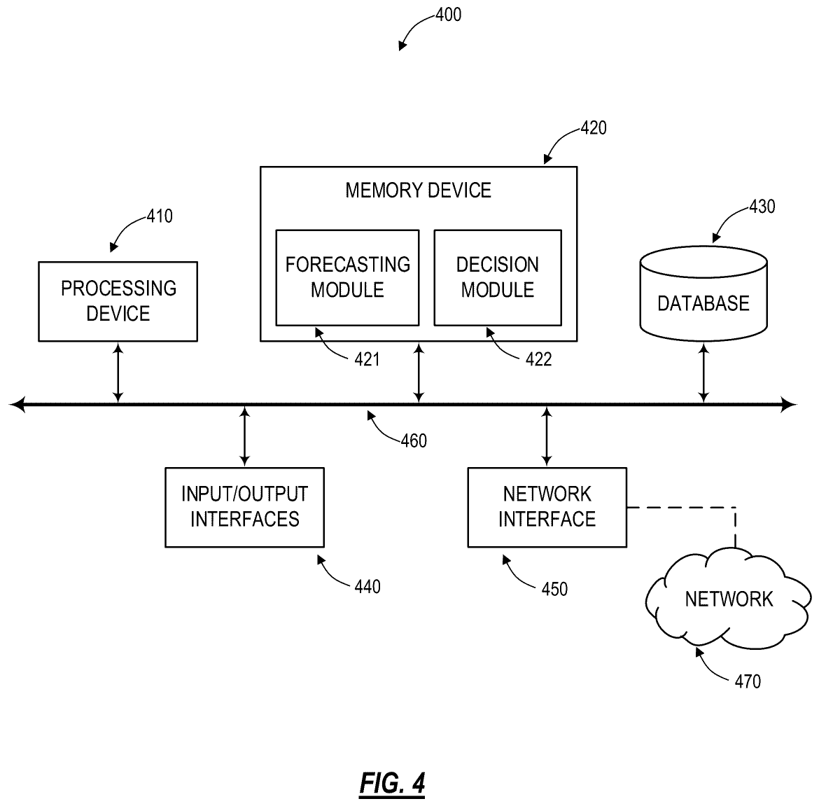

FIG. 4 is a block diagram of a computing system 400 configured to obtain a time-series. From the time-series, the computing system 400 is configured to forecast future data points and provide output regarding the forecast results. Furthermore, according to some embodiments, the computing system 400 may also be configured to make decisions based upon the forecast and/or enact (or instruct other systems to enact) various predetermined actions. In this embodiment, the computing system 400 includes a processing device 410, a memory device 420, a database 430, input/output (1/O) interfaces 440, and a network interface 450, each of which may be interconnected via a local interface 460.

The memory device 420 may be configured as non-transitory computer-readable media and may store one or more software programs, such as a forecasting module 421 and a decision module 422. The software programs may include logic instructions for causing the processing device 410 to perform various steps. For example, the forecasting module 421 may be configured to enable the processing device 410 to process a time-series to calculate a forecast of future data points. The decision module 422 may be associated with the forecasting module 421 and may be configured to make decisions about how to handle the results of the forecast provided by the forecasting module 421.

According to some embodiments, the computing system 400 may be connected within a telecommunications network for obtaining time-series data from the telecommunications network and performing predetermined actions (or giving instructions about actions to be taken) on the telecommunications network based on the forecast results. The network interface 450 of the computing system 400 may, therefore, be connected to a network 470 and obtain time-series information about the network 470. The details of the forecasting module 421 and decision module 422 are described in more detail below for calculating a forecast of various conditions of the network 470 and enacting change on the network 470 as needed based on the forecast. However, the computing system 400 may be utilized in other environments for forecasting other types of systems.

In one or more exemplary embodiments, the control functions described may be implemented in hardware, software, firmware, or any combination thereof. If implemented in software, the functions may be stored on or transmitted over as one or more instructions or code on a computer-readable medium. Computer-readable media includes both storage media and communication media, including any medium that facilitates transferring a computer program from one place to another. A storage medium may be any available media that can be accessed by a computer.

In the illustrated embodiment shown in FIG. 4, the computing system 400 may be a digital computer that, in terms of hardware architecture, generally includes the processing device 410, the memory device 420, the database 430, the I/O interfaces 440, and the network interface 470. The memory device 420 may include a data store, database (e.g., the database 430), or the like. It should be appreciated by those of ordinary skill in the art that FIG. 4 depicts the computing system 400 in a simplified manner, where practical embodiments may include additional components and suitably configured processing logic to support known or conventional operating features that are not described in detail herein. The components (i.e., 410, 420, 430, 440) are communicatively coupled via the local interface 460. The local interface 460 may be, for example, but not limited to, one or more buses or other wired or wireless connections. The local interface 460 may have additional elements, which are omitted for simplicity, such as controllers, buffers, caches, drivers, repeaters, receivers, among other elements, to enable communications. Further, the local interface 460 may include address, control, and/or data connections to enable appropriate communications among the components 410, 420, 430, 440, 450.

The processing device 410 is a hardware device adapted for at least executing software instructions. The processing device 410 may be any custom made or commercially available processor, a central processing unit (CPU), an auxiliary processor among several processors associated with the computing system 400, a semiconductor-based microprocessor (in the form of a microchip or chipset), or generally any device for executing software instructions. When the computing system 400 is in operation, the processing device 410 may be configured to execute software stored within the memory device 420, to communicate data to and from the memory device 420, and to generally control operations of the computing system 400 pursuant to the software instructions.

The I/O interfaces 440 may be used to receive user input from and/or for providing system output to one or more devices or components. The user input may be provided via, for example, a keyboard, touchpad, a mouse, and/or other input receiving devices. The system output may be provided via a display device, monitor, graphical user interface (GUI), a printer, and/or other user output devices. I/O interfaces 440 may include, for example, a serial port, a parallel port, a small computer system interface (SCSI), a serial ATA (SATA), a fiber channel, InfiniBand, iSCSI, a PCI Express interface (PCI-x), an infrared (IR) interface, a radio frequency (RF) interface, and/or a universal serial bus (USB) interface.

The network interface 450 may be used to enable the computing system 400 to communicate over a network, such as the telecommunications network 470, the Internet, a wide area network (WAN), a local area network (LAN), and the like. The network interface 450 may include, for example, an Ethernet card or adapter (e.g., 10BaseT, Fast Ethernet, Gigabit Ethernet, 10 GbE) or a wireless local area network (WLAN) card or adapter (e.g., 802.11 a/b/g/n/ac). The network interface 450 may include address, control, and/or data connections to enable appropriate communications on the telecommunications network 400.

In operation, the network interface 450 is able to obtain a time-series of one or more characteristics or parameters of a particular environment. For instance, the network interface 450 may obtain network time-series data regarding various conditions or features of the network 450. The time-series information may be obtained by using any suitable measurement devices for automatically measuring the information or by any other suitable manner.

A “time-series” is a series of data points obtained progressively over time. In many cases, a time-series may be plotted in a graph with time referenced on the x-axis and some metric, characteristic, or parameters referenced on the y-axis. The time-series may be a sequence of measurements taken at equally-spaced points in time. From the time-series data, the forecasting module 421 is configured to analyze the information to extract meaningful characteristics of the data to devise a forecast or prediction of future values based on the previously-obtained values.

The computing system 400 may be configured as an Artificial Neural Network (ANN) device for processing the time-series in a logical manner to receive input (e.g., time-series data), performing certain processing on the input (e.g., forecasting), and providing some output based on the processing steps (e.g., making changes to the network 470). The ANN device may be configured to process the pieces of information according to a hierarchical or layered arrangement, where the lowest layer may include the input, and the highest layer may include the output. One or more intermediate deep-learning layers may be involved in processing the input to arrive at reasonable outputs. A Deep Neural Network (DNN) may have multiple intermediate layers each having a set of algorithms designed to recognize patterns through clustering, classifying, etc. The recognized patterns may be numerical patterns or vectors

In the environment of a telecommunications network, forecasting can be a fundamental service that can be optimized to enable more efficient network operations. Forecasting may be applicable for the purpose of planning and provisioning network resources that may be needed in the future based on trends. Forecasting in the telecommunications environment may also be useful for operating virtualized network services and for proactively performing maintenance on equipment before the equipment fails.

With the configuration of FIG. 4, the computing system 400 may be employed as a closed-loop forecasting system. Other than the network 470, the computing system 400 can forecast time-series data for use in a number of different environments. When used with the network 470, the forecasting module 421 may be configured to allow a network administrator to enact certain changes to the network 470 based on the forecasting results. For example, one use case of the forecasting processes is for network planning/provisioning. The forecasting module 421 may forecast long-term network demands for network equipment planning. The forecasting module 421 may also forecast medium-term/periodic network demands for proactive connection re-routing and may include a decision to delay equipment purchases. Also, the forecasting module 421 may also be configured to forecast short-term congestion on the network 470 using link utilization information and/or packet loss information. Also, forecasts of congestion may be used for proactively re-routing connections in the network 470. The re-routing may also be based on additional information of the network 470, such as service factors like Quality of Service (QoS) and/or Quality of Experience (QoE) assurance information.

In addition to network planning/provisioning, the results of the forecasting processes of the present disclosure may also be used with respect to virtualized network services. The forecasting module 421 may be configured to forecast server utilization to enable smarter placement of virtualized network functions (VNFs). Also, the forecasting module 421 may be configured to forecast network demand for planning the deployment and/or upgrade of edge computer equipment. The forecasting module 421 may also forecast application demand and instruct the decision module 422 to pre-deploy VNFs, such as content cache, virtual Evolved Packet Core (vEPC), etc.

According to some embodiments, the forecasting module 421 may be utilized based on the following example. The forecasting module 421 may receive a single-variate (or univariate) time-series x(t) for the purpose of forecasting the future values of the time-series x(t). The time-series x(t) may be included within a historical window wₕ, while future values may be included in a future window w_{f}.

At the time of the forecast, past values of the time-series x(t) are available, starting at time t₀. The time-series can, therefore, be written as x(t₀, t₀+Δ, . . . , t₀+(wₕ−1)Δ). At the time of the forecast, future values are not known, and the forecasting module 421 may provide an estimate of these future values, written as \hat{x}(t₀+wₕΔ, to +Δ, . . . , t₀+(wₕ+w_{f})Δ). As the underlying random process evolves, future time-series values become available, so x(to +wₕΔ, to +Δ, . . . , t₀+(wₕ+w_{f})Δ) can be used to check the validity of the estimate \hat{x}(t₀+wₕΔ, to +Δ, . . . , t₀+(wₕ+w_{f})Δ).

The forecasting module 421 of the present disclosure includes at least two key steps that make the forecaster work better than previous approaches. A first key step is that the forecasting module 421 includes a more advanced Deep Neural Network (DNN) architecture than other forecasters. The neural network architecture of the forecasting module 421 creates separate but related forecasting functions for each forecasted time point, as opposed to previous solutions that use one forecasting function for all the forecasted time points. According to some embodiments, this strategy accounts for about two-thirds of our gain of the forecasting module 421.

Another key step involved with the forecasting module 421 is that the forecasting module 421 is configured to generate better forecasting functions. For example, the neural network of the forecasting module 421 uses an inverse Wavelet transform in some layers, which performs better on a wider number of datasets than a Fourier transform. About one-third of our gain of the forecasting module 421 comes from the inverse Wavelet transform processes.

Despite the large size of the DNN of the forecasting module 421, it can be trained for tens of thousands of time-series points in a matter of single-digit minutes on a laptop and can make forecasts on the laptop on the order of milliseconds. When used with a Graphics Processing Unit (GPU) or Tensor Processing Unit (TPU), the computational performance may be significantly better.

Implementation of the Time-Series Predicting Architecture from FIG. 2 on the Dataset in FIG. 1

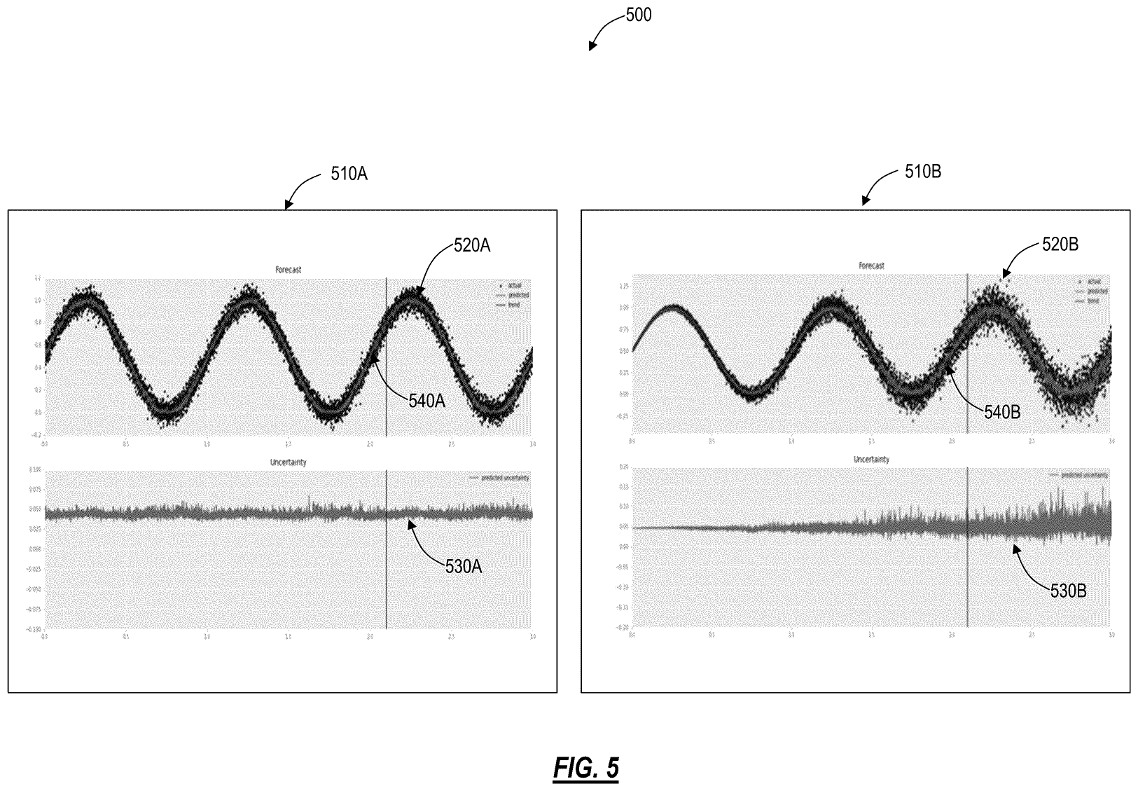

FIG. 5 illustrates the implementation of the predicting architecture of FIG. 2 as described in the disclosure using the time-series data shown in FIG. 1. The use of synthetic dataset allows control of the type and volume of noise and works to represent a test for a true dataset. 510A shows a dataset with constant intensity noise where 510B shows time varying noise on the dataset. It should be noted in 510A that 530A represents the predicted uncertainty, the data points in 520A represent the actual uncertainty, and the line shown between the data points 540A represents the data trendline. The error is not shown as this represents a synthetic dataset, but the error is very small according to the disclosure. 510B shows how well the time varying noise is estimated and predicted, notice that the intensity of the predicted noise 530B is increasing as it does in the actual data 520B. Statistical analysis was not performed on this as it is believed that the precise estimates of the noise may not be useful. What is more important is an estimate of how confident we can be in some samples compared to other samples. As the forecasting is conducted in real time active network systems, over time the DNN will be receiving feedback from new measurements and the confidence estimation will improve throughout learning more about the noise in the data.

### CONCLUSION

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A method comprising steps of:
receiving a time-series that includes a historical or current observation;
determining future points of the time-series utilizing a forecasting deep neural network (DNN) to analyze the time-series;
determining an uncertainty of the future points utilizing an uncertainty DNN to analyze the time-series; and
providing the future points of the time-series and the uncertainty.

2. The method of claim 1, wherein the steps further include
utilizing the uncertainty DNN to analyze the time-series and the future points.

3. The method of claim 1, wherein the steps further include performing the determining steps concurrently.

4. The method of claim 1, wherein the forecasting DNN and the uncertainty DNN include various components including any of dense layers, long short-term memory (LSTM) layers, pooling layers, and convolutional layers.

5. The method of claim 1, wherein the forecasting DNN and the uncertainty DNN include different components.

6. The method of claim 1, wherein the uncertainty includes a range over time.

7. The method of claim 1, wherein the steps further include
training the forecasting DNN with historical data; and
training the uncertainty DNN with the trained forecasting DNN utilizing a residual of an estimate from the forecasting DNN and actual data in the historical data.

8. The method of claim 1, wherein the uncertainty is any of a variance of noise, a probability the noise is higher than a threshold, and a sign of the noise.

9. The method of claim 1, wherein the time-series includes performance monitoring (PM) data from a network.

10. A non-transitory computer-readable medium configured to store a program executable by a processing system, the program including instructions configured to cause the processing system to perform steps of:
receiving a time-series that includes a historical or current observation;
determining future points of the time-series utilizing a forecasting deep neural network (DNN) to analyze the time-series;
determining an uncertainty of the future points utilizing an uncertainty DNN to analyze the time-series; and
providing future points of the time-series and the uncertainty.

11. The non-transitory computer-readable medium of claim 10, wherein the steps further include
utilizing the uncertainty DNN to analyze the time-series and the future points.

12. The non-transitory computer-readable medium of claim 10, wherein the steps further include
performing the determining steps concurrently.

13. The non-transitory computer-readable medium of claim 10, wherein the forecasting DNN and the uncertainty DNN include various components including any of dense layers, long short-term memory (LSTM) layers, pooling layers, and convolutional layers.

14. The non-transitory computer-readable medium of claim 10, wherein the forecasting DNN and the uncertainty DNN include different components.

15. The non-transitory computer-readable medium of claim 10, wherein the uncertainty includes a range over time.

16. The non-transitory computer-readable medium of claim 10, wherein the steps further include
training the forecasting DNN with historical data; and
training the uncertainty DNN with the trained forecasting DNN utilizing a residual of an estimate from the forecasting DNN and actual data in the historical data.

17. The non-transitory computer-readable medium of claim 10, wherein the uncertainty is any of a variance of noise, a probability the noise is higher than a threshold, and a sign of the noise.

18. The non-transitory computer-readable medium of claim 10, wherein the time-series includes performance monitoring (PM) data from a network.

19. A computing system comprising:
a processing device and memory comprising instructions that, when executed, cause the processing device to
receive a time-series that includes a historical or current observation,
determine future points of the time-series utilizing a forecasting deep neural network (DNN) to analyze the time-series,
determine an uncertainty of the future points utilizing an uncertainty DNN to analyze the time-series, and
provide future points of the time-series and the uncertainty.

20. The computing system of claim 19, wherein the instructions that, when executed, cause the processing device to
utilize the uncertainty DNN to analyze the time-series and the future points.
